(19) United States
(12) Patent Application Publication
(10) Pub. No.: US 2026/0149551 A1
(43) Pub. Date: May 28, 2026

(54) TAYLOR EXPANSION APPROXIMATION BASED DIRECT FREQUENCY DOMAIN AUTOCORRELATION FUNCTION ESTIMATION AND APPLICATIONS

(71) Applicant: Sequans Communications SA, Colombes (FR)

(72) Inventors: Alon Yaakov Sidi, Rehovot (IL); Maxim Gotman, Netanya (IL)

(21) Appl. No.: 18/962,262

(22) Filed: Nov. 27, 2024

(51) Int. Cl. H04L 5/02; H04L 5/00

(52) U.S. Cl. CPC H04L 5/023; H04L 5/0007; H04L 5/0048

(57) ABSTRACT

Systems and methods for frequency domain (FD) channel autocorrelation function estimation in a communication system are disclosed. An example method includes obtaining noisy frequency domain samples, y[m], from a reference signal in an Orthogonal Frequency Division Multiplexing (OFDM) communication system. The example method also includes estimating the frequency domain channel autocorrelation function Rₕₕ[k]. Additionally, the example method includes calculating a noise-reduced channel autocorrelation function estimate at position 0, Rₕₕ[0], by interpolating the noisy frequency domain channel autocorrelation samples Rₕₕ[k] at positions other than 0.

### TECHNICAL FIELD

The present disclosure relates generally to communication systems and, more specifically, to systems and methods for frequency domain autocorrelation function estimation.

### BACKGROUND

Modern communication systems, such as those used in Fourth Generation (4G) and Fifth Generation (5G) networks, rely on accurate channel estimation and performance metrics to ensure reliable data transmission and optimal network operation. Techniques for estimating channel properties, such as the autocorrelation function in the frequency domain, play a critical role in tasks including synchronization, interference management, and adaptive signal processing.

Many existing approaches aim to estimate channel properties using indirect time domain (TD) methods, which may involve intermediate steps that introduce noise or reduce the accuracy of the estimations. These challenges can impact overall system performance, including metrics like signal-to-noise ratio (SNR), carrier-to-interference-plus-noise ratio (CINR), and delay spread calculations, which are vital for efficient communication.

Accordingly, there is a need for improved methods and systems for direct frequency domain autocorrelation function estimation to enhance accuracy and efficiency in communication systems.

### SUMMARY

Some embodiments provide systems, methods, and devices for accurately estimating the channel autocorrelation function in communication systems using noisy signal data. Channel correlation may play an important role in channel estimation by enabling the prediction of channel characteristics based on observed data, which is essential for tasks like synchronization, interference management, and adaptive signal processing. Autocorrelation coefficients, such as those used in this disclosure, provide a basis for estimating channel responses, which in turn enhance the precision and reliability of channel estimation. This may be achieved by processing noisy frequency domain samples from reference signals in Orthogonal Frequency Division Multiplexing (OFDM) systems, estimating the autocorrelation function, and applying advanced interpolation techniques to reduce noise and improve accuracy in the estimation. This may enable enhanced performance and reliability in communication channels.

An example method for frequency domain (FD) channel autocorrelation function estimation in a communication system includes obtaining noisy frequency domain samples, y[m], from a reference signal in an OFDM communication system. The example method also includes estimating the frequency domain channel autocorrelation function Rₕₕ[k]. Additionally, the example method includes calculating a noise-reduced channel autocorrelation function estimate at position 0, Rₕₕ[0], by interpolating the noisy frequency domain channel autocorrelation samples Rₕₕ[k] at positions other than 0.

An example device is configured for FD channel autocorrelation function estimation in a communication system. The device includes at least one memory and at least one processor coupled to the at least one memory. The at least one processor is configured to obtain noisy frequency domain samples, y[m], from a reference signal in an OFDM communication system. The at least one processor is also configured to estimate the frequency domain channel autocorrelation function Rₕₕ[k]. Additionally, the at least one processor is configured to calculate a noise-reduced channel autocorrelation function estimate at position 0, Rₕₕ[0], by interpolating the noisy frequency domain channel autocorrelation samples Rₕₕ[k] at positions other than 0.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 is a graph depicting the block error rate (BLER) comparison for Extended Typical Urban (ETU) 1×2 testing between using estimated TD PDP-based Rih calculations and the proposed direct FD Rₕₕ calculation method.

FIG. 2 is a graph illustrating the channel estimation error vector magnitude (EVM) comparison for ETU 1×2 testing between using estimated TD PDP-based Rₕₕ calculations and the proposed direct FD Rₕₕ calculation method.

FIG. 3 is a graph illustrating the SNR estimation accuracy comparison for Extended Vehicular A (EVA) 1×4 testing between the Genic/estimated TD PDP calculation and the proposed direct FD Rₕₕ calculation method.

FIG. 4 is a block diagram illustrating a top-level schematic view of the invention, illustrating the reference signals and their use in R_{yy} estimation and channel estimation.

FIG. 5 is a graph illustrating the mean square error (MSE) performance of Taylor interpolation for Rih across various orders of approximation in the absence of estimation noise.

FIG. 6 is a flowchart illustrating an example method in accordance with the systems and methods described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Advancements in signal processing, such as the application of interpolation techniques using Taylor expansions, are providing new opportunities to enhance the accuracy of channel estimation. These methods address the limitations of traditional approaches, reducing noise impact and improving system reliability. However, their practical implementation in real-time communication systems requires novel methods to dynamically adjust and optimize estimation parameters.

Some embodiments introduce systems and methods for accurately estimating the frequency domain channel autocorrelation function Rₕₕ[k] in communication systems, particularly in Orthogonal Frequency Division Multiplexing (OFDM) systems. In some example embodiments, these methods may bypass intermediate steps that traditionally introduce noise and inaccuracies, providing a noise-reduced estimation of Rₕₕ[k], with a specific focus on the value Rₕₕ[0], representing the autocorrelation at zero lag. The system may achieve this through advanced mathematical techniques, such as Taylor expansion interpolation, applied to noisy signal data from reference signals in modern communication systems.

In an example embodiment, the process begins with obtaining noisy frequency domain samples y[m] from a reference signal, such as a secondary synchronization signal (SSS) in OFDM-based communication systems. These noisy samples may include signal contributions combined with interference and noise, complicating direct calculations of Rₕₕ[k]. To address this, some embodiments may estimate Rₕₕ[k] at various non-zero positions and use those estimates to interpolate and calculate Rₕₕ[0], effectively reducing the estimation's noise variance that would otherwise distort the result. The interpolation may employ Taylor expansion approximations for both cosine and sine functions, providing accurate intermediate values for Rₕₕ[k]. These approximations may reduce dependence on calculations, such as those based on the power delay profile (PDP), which are more prone to error due to noise propagation.

An example embodiment may also incorporate dynamic adaptability to various reference signals, including cell-specific reference signals (C-RS), demodulation reference signals (DM-RS), and channel state information reference signals (CSI-RS) or any other equally spaced FD reference signals. This capability may help ensure compatibility with different communication modes and enhance accuracy under a range of bandwidths and channel conditions. The reference signal may be dynamically selected based on the operating environment, potentially maximizing estimation fidelity in some aspects.

To enhance signal processing, some embodiments may adjust the antenna weighting matrix Λ and other parameters, such as the parameter γ, based on the variance of noise errors. This dynamic optimization may accelerate convergence in the autocorrelation function estimation process and may improve the reliability of the communication system. In addition, interpolation techniques extend the estimated values of Rₕₕ[k] for smaller sub-carrier spacings Δf′=Δf/l, allowing the system to adapt to different channel configurations.

Some embodiments relate to systems and methods for direct frequency domain autocorrelation function estimation and their applications in enhancing performance metrics such as channel estimation, carrier-to-interference-plus-noise ratio (CINR), and delay spread in OFDM communication systems.

In some embodiments, the FD channel autocorrelation function may be understood as a mathematical representation of the similarity between channel responses at different frequencies in a communication system. For example, this function may quantify the relationship between signals received at varying frequency intervals and can be used to describe the channel's characteristics, such as fading or delay properties. The FD channel autocorrelation function Rₕₕ[k] may represent the expected value of the product of the frequency domain channel response at a given frequency with the complex conjugate of the channel response at a shifted frequency.

The Taylor expansion-based interpolation leverages the mathematical properties of cosine and sine functions to refine the channel autocorrelation estimates Rₕₕ[k]. This approach approximates higher-order frequency terms to account for noise and interference more effectively, resulting in smoother and more accurate interpolated values. By dynamically selecting interpolation orders based on real-time conditions, the system ensures adaptability across varying noise environments.

The weighted summation of delay values, derived from interpolating the imaginary components of Rₕₕ[k], provides a precise calculation of the average delay spread (t). This delay spread is a critical metric for synchronizing communication systems, especially in multipath propagation environments. The use of Taylor expansions ensures that interpolated values maintain high fidelity, even under conditions of significant interference.

Delay spread, a metric for timing and synchronization in communication systems, may also be calculated, e.g., with high precision. An example embodiment may compute both the average delay spread t and the root mean square (RMS) delay spread using Rₕₕ[0] and interpolated values from Rₕₕ[1:M]. The weighted summation of delay values for t may be determined by interpolating, e.g., the imaginary part of Rₕₕ[k], with Taylor expansions improving the accuracy of these interpolations. This precision may be particularly important in environments with significant noise or interference, enabling robust synchronization and timing adjustments in OFDM systems.

CINR may also be calculated using the systems and methods described herein. In an example embodiment, the systems and methods described herein may apply a leaky alpha filter to smooth R_{yy}[k] over time, reducing noise variance and providing more accurate CINR calculations. These improvements ensure that the system can adapt to varying interference and noise levels while maintaining reliable performance.

The estimation of the FD channel autocorrelation function may involve deriving approximate values for Rₕₕ[k] from observed data, which may include noise. An example embodiment may achieve this by processing noisy frequency domain samples, denoted as y[m], which may represent received signals combined with interference and noise. These samples may be obtained from a reference signal, such as a synchronization signal used in OFDM systems. OFDM communication systems may use multiple orthogonal subcarriers to transmit data, and they are commonly employed in modern wireless networks such as 4G and 5G.

In some implementations, y[m] may represent noisy FD samples of the channel's response to the reference signal, where y[m]=h[m]+n[m]. Here, h[m] may describe the actual FD channel response, and n[m] may denote the noise contribution at sub carrier m. To calculate a noise-reduced estimate of the FD channel autocorrelation function at position 0, Rₕₕ[0], the noisy autocorrelation samples Rₕₕ[k] at positions other than 0 may be interpolated. For example, interpolation techniques, such as a Taylor expansion approximation, may use mathematical series to compute intermediate or refined values of the autocorrelation function.

In addition to improving channel estimation, the direct calculation of Rₕₕ[0] enables accurate CINR measurements. These measurements, derived from the ratio of signal power to interference-plus-noise power, are critical for adaptive resource allocation in modern wireless systems. The leaky alpha filter applied to R_{yy}[k] estimates further stabilizes CINR values over time, enhancing system performance under fluctuating conditions.

An embodiment of the interpolation process may involve calculating both real and imaginary components of the noisy autocorrelation samples, which may be represented as Re{Rₕₕ[k]} and Im{Rₕₕ[k]}. These components may then be used to estimate delay metrics or refine the channel response estimation. For example, the delay spread, t, may describe the time dispersion of a signal caused by multipath propagation and may be calculated using interpolated values of the autocorrelation function. Similarly, the CINR, which may be an indicator of signal quality, may be derived from Rₕₕ[0] and the noisy signal autocorrelation R_{yy}[0], using relationships such as CINR=Rₕₕ[0]/(R_{yy}[0]−Rₕₕ[0]).

In some embodiments, a weighting matrix A and parameter γ may be dynamically adjusted during the estimation process to account for noise and signal power variations. These adjustments may optimize the convergence of the channel autocorrelation function estimation and may be applied in systems with multiple antennas. For instance, antenna weights may be updated based on the estimated noise variance to enhance estimation accuracy under varying interference conditions.

Extrapolation of Rₕₕ[k] to smaller subcarrier spacings extends the method's applicability to diverse communication systems, including those with reference signals which have subcarrier spacing larger than 1. By leveraging matrix transformations on interpolated Rₕₕ[k] values, the system can efficiently estimate autocorrelation functions across varying frequency resolutions, enabling compatibility with both high-density and low-density subcarrier configurations.

The autocorrelation function Rₕₕ[k] may also be extrapolated to support communication systems with diverse bandwidths and configurations to account for smaller subcarrier spacings. For example, a matrix transformation based on interpolation techniques may generate Rₕₕ values for higher resolution frequency grids in an embodiment. These enhancements may ensure compatibility with reference signals of different densities and enable more precise channel estimations in low-bandwidth and high-bandwidth scenarios.

The terms described above reflect some of the technical aspects and innovations addressed by the embodiments disclosed in the specification. By providing a detailed process for estimating Rₕₕ[k], applying noise filtering, and enhancing interpolation techniques, these systems and methods may improve the accuracy and reliability of channel estimation in OFDM communication systems.

The FD autocorrelation function may be defined as:

$${R}_{hh} ( k Δ f ) = {R}_{hh} [ k ] {=}^{△} E \{ h [ m ] \cdot {h}^{*} [ m + k ] \} = {\sum }_{n = 0}^{{N}_{pt} - 1} {P}_{n} {e}^{j 2 π k Δ f {τ}_{n}} , \qquad ( 1 )$$

where the {Pₙ, τₙ} pairs represent the PDP of the channel. Knowledge of this function has many applications in OFDM communications system and particularly in 4G/5G systems: the 4^{th} order Minimum Mean Squared Error (MMSE) solution for the Cell-Specific Reference Signal (CRS) based channel estimation calculates the frequency domain interpolation coefficients w[n] according to:

$${R}_{yh} [ n ] {=}^{△} [ \begin{matrix}{R}_{yh} [ n + 6 ] \\ {R}_{yh} [ n ] \\ {R}_{yh} [ n - 6 ] \\ {R}_{yh} [ n - 12 ]\end{matrix} ] \qquad ( 2 )$$

$${R}_{yy} {=}^{△} [ \begin{matrix}{R}_{yy} [ 0 ] & {R}_{yy} [ 6 ] & {R}_{yy} [ 12 ] & {R}_{yy} [ 18 ] \\ {R}_{yy} [ - 6 ] & {R}_{yy} [ 0 ] & {R}_{yy} [ 6 ] & {R}_{yy} [ 12 ] \\ {R}_{yy} [ - 12 ] & {R}_{yy} [ - 6 ] & {R}_{yy} [ 0 ] & {R}_{yy} [ 6 ] \\ {R}_{yy} [ - 18 ] & {R}_{yy} [ - 12 ] & {R}_{yy} [ - 6 ] & {R}_{yy} [ 0 ]\end{matrix} ]$$

$$w [ n ] {=}^{△} [ \begin{matrix}{w}^{*} [ 0 , n ] \\ {w}^{*} [ 1 , n ] \\ {w}^{*} [ 2 , n ] \\ {w}^{*} [ 3 , n ]\end{matrix} ] = {R}_{yy}^{- 1} ( {R}_{yh} [ n ] + ( \frac{1 - {1}^{T} {R}_{yy}^{- 1} {R}_{yh} [ n ]}{{1}^{T} {R}_{yy}^{- 1} 1} ) 1 )$$

where:

$${R}_{yy} [ k ] {=}^{△} E \{ y [ m ] \cdot {y}^{*} [ m + k ] \} = \{ \begin{matrix}{R}_{hh} [ 0 ] + {σ}^{2} & k = 0 \\ {R}_{hh} [ k ] & k > 0\end{matrix} ,$$

R_{yh}[k]=Rₕₕ[k], and
y[m]=h[m]+n[m] is the noisy frequency domain sample of the m^{th} sub-carrier of the M-sequence removed SSS.

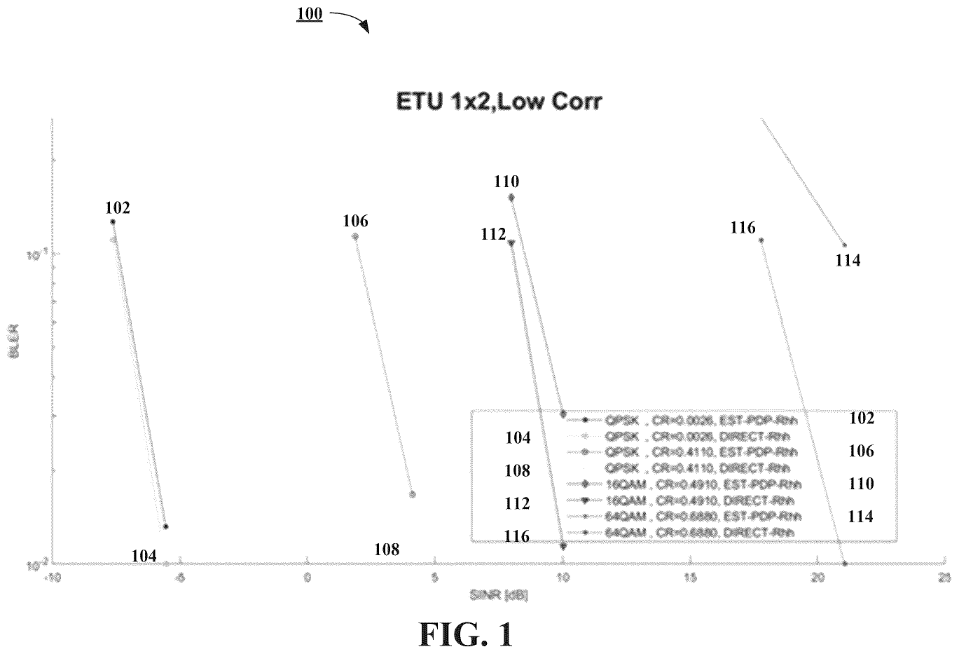

FIG. 1 is a diagram 100 illustrates an ETU 1×2 BLER comparison using Estimated PDP Rₕₕ/Direct Rₕₕ calculation. FIG. 1 illustrates QPSK, CR=0.0026, EST-PDP-Rₕₕ 102, QPSK, CR=0.0026, DIRECT-Rₕₕ 104, QPSK, CR=0.4110, EST-PDP-Rₕₕ 106, QPSK, CR=0.4110, DIRECT-Rₕₕ 108, QPSK, CR=0.4910, EST-PDP-Rₕₕ 110, QPSK, CR=0.4910, DIRECT-Rₕₕ 112, QPSK, CR=0.6880, EST-PDP-Rₕₕ 114, QPSK, CR=0.6880, DIRECT-Rₕₕ 116,

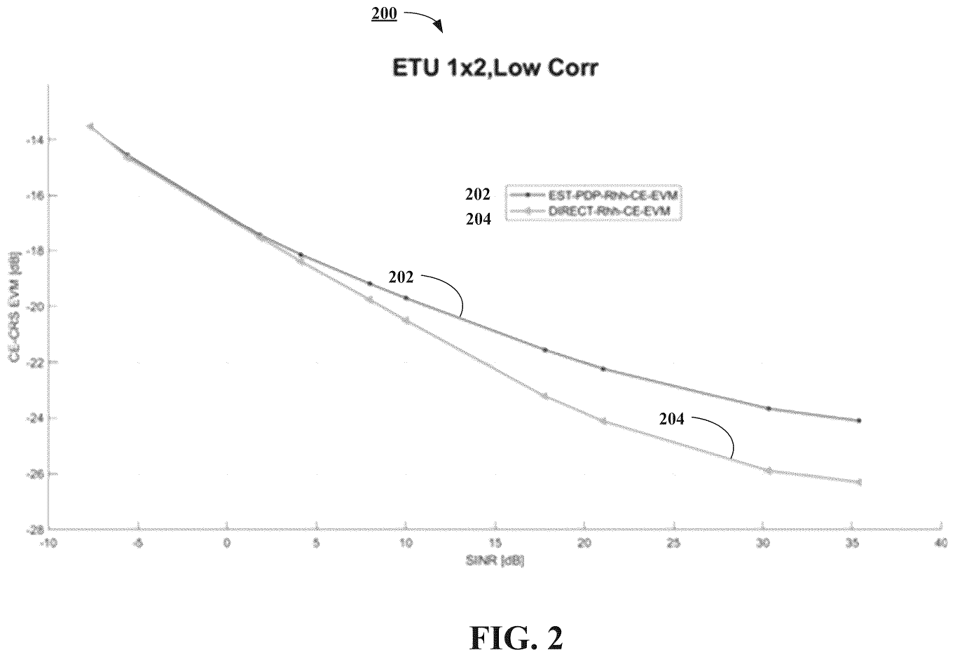

FIG. 2 illustrates an ETU 1×2 channel estimation EVM comparison using Estimated PDP Rₕₕ 202/Direct Rₕₕ calculation 204. As can be seen in FIG. 1, for high SNR values, significant SNR loss is observed, which is easily explained using FIG. 2, which presents the reduced accuracy of the channel estimation via the EVM testing when the estimated PDP Rₕₕ calculation is used.

FIG. 1—FIG. 2 give the motivation for an alternative calculation of (1). Given that R_{yy}[0] is also estimated, then the CINR calculation, which may be used to configure many blocks in the system, can be set according to:

$$CINR {=}^{△} \frac{signal power}{noise and interference power} = \frac{{R}_{hh} [ 0 ]}{{R}_{yy} [ 0 ] - {R}_{hh} [ 0 ]} . \qquad ( 3 )$$

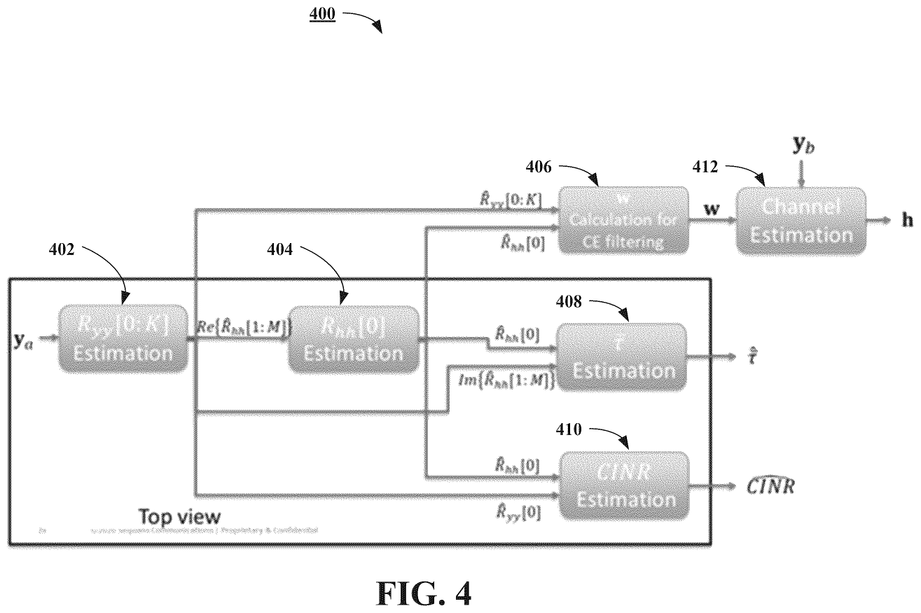

Here again, this calculation may be performed while manipulating the estimated PDP values. When comparing the accuracy of this calculation when using the estimated PDP Rₕₕ calculation vs the using the results of the proposed Direct Rₕₕ calculation a notable accuracy gain is observed as presented in FIG. 4. This behavior has significant impact on the behavior of the system.

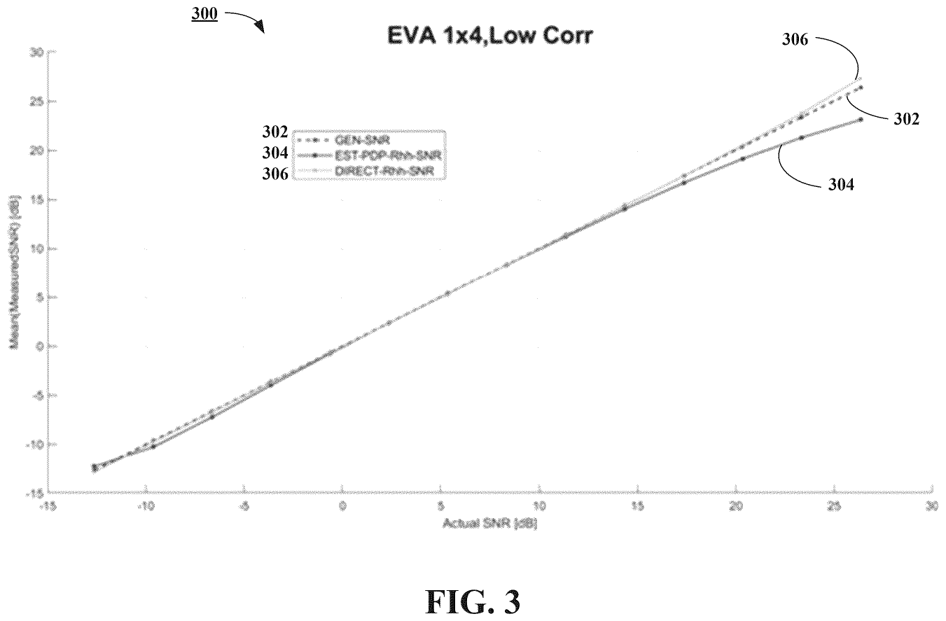

FIG. 3—EVA 1×4 SNR estimation comparison between using Genie 302/Estimated PDP calculation 304 and direct calculation 306.

The average Delay Spread t used for timing adjustments of the system:

$$\overline{τ} {=}^{△} \frac{{\sum }_{n = 0}^{{N}_{pt} - 1} {P}_{n} {τ}_{n}}{{\sum }_{n = 0}^{{N}_{pt} - 1} {P}_{n}} = \frac{{\sum }_{n = 0}^{{N}_{pt} - 1} {P}_{n} {τ}_{n}}{{R}_{hh} [ 0 ]} . \qquad ( 4 )$$

As can be observed in FIG. 1-FIG. 3, knowledge of (2,3,4) may be necessary in 4G/5G systems and may be performed by first estimating the {Pₙ, τₙ} pairs and then substituting in (1-4) then this initial estimation stage provides limited accuracy and hence it degrades the overall performance of the system.

This patent proposal describes an alternative method of estimating Rₕₕ[k] directly using the SSS (or other reference signals) in the frequency domain as well as

$${\sum }_{n = 0}^{{N}_{pt} - 1} {P}_{n} {τ}_{n}$$

without the PDP TD estimation stage while using the Taylor Expansion properties of (1) and thus achieving enhanced performance of the system.

The direct estimation of Rₕₕ[k] means that the FD samples of the LTE's SSS signal are autocorrelated as

$${\hat{R}}_{hh} [ k ] = \frac{1}{{N}_{rx} ( 63 - k - {N}_{DC Mult} [ k ] )} {\sum }_{m = 0}^{62 - k} {y}^{*} [ m + k ] y [ m ] .$$

This however means that Rₕₕ[0] cannot be estimated since \hat{R}ₕₕ[0] effectively estimates Rₕₕ[0]+σ² instead, that is, it also includes the (unwanted) noise variance of the signal. The normalization factor

$$\frac{1}{{N}_{rx} ( 63 - k - {N}_{DC Mult} [ k ] )}$$

is adjusted for the LTE SSS signal, therefore, when a different reference signal is used it may be adjusted accordingly with respect of this signal.

The core of the invention (i.e., the independent claims)

To get an estimation of Rₕₕ[0] (without the σ² term), this patent proposal describes a nearly unbiased method to linearly estimate Rₕₕ[0] from the noisy (zero mean noise) estimation of [Rₕₕ[1], . . . , Rₕₕ[M]] using an (M−1)×1 precalculated real vector a as:

$${\hat{R}}_{hh} [ 0 ] = Re \{ {\hat{R}}_{hh} [ 1 ] \} + {a}^{T} [ \begin{matrix}Re \{ {\hat{R}}_{hh} [ 1 ] - {\hat{R}}_{hh} [ 2 ] \} \\ ⋮ \\ Re \{ {\hat{R}}_{hh} [ M - 1 ] - {\hat{R}}_{hh} [ M ] \}\end{matrix} ] ,$$

Where the vector a may be chosen using any method although in this patent proposal the Taylor expansion of cos(x) is used to calculate it.

In a similar manner an estimation of the average delay

$$\overline{τ} {=}^{△} \frac{{\sum }_{n = 0}^{{N}_{pt} - 1} {P}_{n} {τ}_{n}}{{R}_{hh} [ 0 ]}$$

which is needed as part of the acquisition of the channel delay properties also uses the noisy (zero mean noise) estimation of [Rₕₕ[1], . . . , Rₕₕ[M]] via:

$$\hat{\overline{τ}} = \frac{{\hat{R}}_{hh} [ 0 ]}{} = \frac{{b}^{T} [ \begin{matrix}Im \{ {\hat{R}}_{hh} [ 1 ] \} \\ ⋮ \\ Im \{ {\hat{R}}_{hh} [ M ] \}\end{matrix} ]}{{\hat{R}}_{hh} [ 0 ]} ,$$

where b is an M×1 precalculated real vector which may be chosen in any manner although in this patent proposal the Taylor expansion of sin(x) is used to calculate it. Using \hat{R}ₕₕ[0] and \hat{R}_{yy}[0] the CINR is estimated via:

$$CINR = \frac{{\hat{R}}_{hh} [ 0 ]}{{\hat{R}}_{yy} [ 0 ] - {\hat{R}}_{hh} [ 0 ]}$$

A top view of the system. It is important to note that the described methods are applicable to other reference signals in the 4G/5G domain, for instance the New Radio (NR) SSS, Long Term Evolution (LTE, 4G standard) CRS and LTE/NR DM-RS signals etc.

Thus, the following figure illustrates the top view of the invention using the yₐ reference signal for R_{yy} estimation while the channel estimation block uses the y_{b} reference signal to produce h, though yₐ may equal y_{b} as well.

FIG. 4 is a block diagram 400 illustrating a top-level schematic view of the invention, illustrating the reference signals and their use in R_{yy} estimation and channel estimation. The block diagram 400 includes an input yₐ to R_{yy}[0: K] block 402 and outputs the real part of Rₕₕ[1:M] where 2≤M≤K to an Rₕₕ[0] Estimation block 404 which outputs Rₕₕ[0]. A tau estimation block 408 may generate tau from outputs Rₕₕ[0] and the imaginary part of Rₕₕ[1:M]. The w calculation for CE filtering 406 may generate w from R_{yy}[0: K] and Rₕₕ[0]. The w and y_{b} may be used for channel estimation in block 412 to generate h. CINR estimation block 410 may generate CINR from Rₕₕ[0] and R_{yy}[0].

Some embodiments may use a Taylor Expansion Based Rₕₕ[0] and

$${\sum }_{n = 0}^{{N}_{pt} - 1} {P}_{n} {τ}_{n}$$

and/or approximations using Rₕₕ[1:M]. This section describes an optimal calculation of the vectors a and b described herein. Observing (1), Rₕₕ[k] can be approximated for small Δf using the Taylor expansion for

$$cos ( x ) {=}^{Δ} {\sum }_{q = 0}^{∞} \frac{{( - 1 )}^{q} {( x )}^{2 q}}{( 2 q ) !} and sin ( x ) {=}^{Δ} {\sum }_{q = 0}^{∞} \frac{{( - 1 )}^{q} {( x )}^{2 q + 1}}{( 2 q + 1 ) !}$$

$${R}_{h h} [ k ] {=}^{Δ} {\sum }_{n = 0}^{{N}_{p t} - 1} {P}_{n} {e}^{j 2 π k Δ f {τ}_{n}} = {\sum }_{n = 0}^{{N}_{p t} - 1} {P}_{n} ( cos 2 π k Δ f {τ}_{n} + j sin 2 π k Δ f {τ}_{n} ) = ( {\sum }_{n = 0}^{{N}_{p t} - 1} {P}_{n} {\sum }_{q = 0}^{∞} \frac{{( - 1 )}^{q} {( 2 π k Δ f {τ}_{n} )}^{2 q}}{( 2 q ) !} ) + j ( {\sum }_{n = 0}^{{N}_{p t} - 1} {P}_{n} {\sum }_{q = 0}^{∞} \frac{{( - 1 )}^{q} {( 2 π k Δ f {τ}_{n} )}^{2 q + 1}}{( 2 q + 1 ) !} ) = ( {\sum }_{q = 0}^{∞} \frac{{( - 1 )}^{q} {k}^{2 q}}{( 2 q ) !} {\sum }_{n = 0}^{{N}_{p t} - 1} {{P}_{n} ( 2 π Δ f {τ}_{n} )}^{2 q} ) + j ( {\sum }_{q = 0}^{∞} \frac{{( - 1 )}^{q} {k}^{2 q + 1}}{( 2 q + 1 ) !} {\sum }_{n = 0}^{{N}_{p t} - 1} {{P}_{n} ( 2 π Δ f {τ}_{n} )}^{2 q + 1} ) = ( ( {\sum }_{n = 0}^{{N}_{p t} - 1} {P}_{n} ) + ( {\sum }_{q = 1}^{∞} \frac{{( - 1 )}^{k} {k}^{2 q}}{( 2 q ) !} {\sum }_{n = 0}^{{N}_{p t} - 1} {{P}_{n} ( 2 π Δ f {τ}_{n} )}^{2 q} ) ) + j ( {\sum }_{q = 0}^{∞} \frac{{( - 1 )}^{q} {k}^{2 q + 1}}{( 2 q + 1 ) !} {\sum }_{n = 0}^{{N}_{p t} - 1} {{P}_{n} ( 2 π Δ f {τ}_{n} )}^{2 q + 1} ) {=}^{Δ} ( {R}_{h h} [ 0 ] + {\sum }_{q = 1}^{∞} \frac{{( - 1 )}^{q} {k}^{2 q}}{( 2 q ) !} {v}_{r} [ q - 1 , Δ f ] ) + j ( {\sum }_{q = 0}^{∞} \frac{{( - 1 )}^{q} {k}^{2 q + 1}}{( 2 q + 1 ) !} {v}_{i} [ q , Δ f ] ) \qquad ( 5 )$$

When focusing on the real part of (5), it can be observed that if we have exact knowledge about the values of Re{Rₕₕ[1]}, Re{Rₕₕ[2]}, . . . , Re{Rₕₕ[M]}, then we can with any desired accuracy with respect to M approximate for m≥1:

$${p}_{r} [ m - 1 ] {=}^{Δ} Re \{ {R}_{h h} [ m ] - {R}_{h h} [ m + 1 ] \} ≅ {\sum }_{q = 1}^{M - 1} \frac{{( - 1 )}^{q} ( {m}^{2 q} - {( m + 1 )}^{2 q} )}{( 2 q ) !} {v}_{r} [ q - 1 , Δ f ] . \qquad ( 6 )$$

### Defining:

$${v}_{r} [ Δ f ] {=}^{Δ} {[ {v}_{r} [ 0 , Δ f ] , … , {v}_{r} [ M - 2 , Δ f ] ]}^{T} , {P}_{r} {=}^{Δ} {[ {p}_{r} [ 0 ] , … , {p}_{r} [ M - 2 ] ]}^{T} , {c}_{r} [ k ] {=}^{Δ} [ \frac{- {k}^{2}}{2 !} , \frac{{k}^{4}}{4 !} , … , \frac{{( - 1 )}^{M - 1} {k}^{2 M - 2}}{( 2 M - 2 ) !} ] , k \geq 1 , {D}_{r} [ m , q ] {=}^{Δ} \frac{{( - 1 )}^{q + 1} ( {( m + 1 )}^{2 ( q + 1 )} - {( m + 2 )}^{2 ( q + 1 )} )}{( 2 ( q + 1 ) ) !} , 0 \leq m , q \leq M - 2 \qquad ( 7 )$$

then the following can be stated:

$${p}_{r} ≅ {D}_{r} {v}_{r} [ Δ f ] ⇒ {v}_{r} [ Δ f ] ≅ {D}_{r}^{- 1} {p}_{r} . \qquad ( 8 )$$

Thus, using (6-8), Rₕₕ[0] can be approximated via:

$${\hat{R}}_{h h} [ 0 ] ≅ Re \{ {R}_{h h} [ 1 ] \} - {c}_{r} [ 1 ] {v}_{r} [ Δ f ] = Re \{ {R}_{h h} [ 1 ] \} - {c}_{r} {D}_{r}^{- 1} {p}_{r} . \qquad ( 9 )$$

As an example, for an order 4 approximation we have:

$${\hat{R}}_{h h}^{o r der 4} [ 0 ] = Re \{ {R}_{h h} [ 1 ] \} - {[ \frac{- 1}{2 !} , \frac{1}{4 !} ] [ \begin{matrix}\frac{3}{2 !} & \frac{- 15}{4 !} \\ \frac{5}{2 !} & \frac{- 65}{4 !}\end{matrix} ]}^{- 1} [ \begin{matrix}Re \{ {R}_{h h} [ 1 ] \} - Re \{ {R}_{h h} [ 2 ] \} \\ Re \{ {R}_{h h} [ 2 ] \} - Re \{ {R}_{h h} [ 3 ] \}\end{matrix} ] . \qquad ( 10 )$$

In order to test this derivation a MATLAB script was developed to measure the

$$MSE {=}^{Δ} 10 {log}_{10} ( {( \frac{{R}_{h h} [ 0 ] - {\hat{R}}_{h h} [ 0 ]}{{R}_{h h} [ 0 ]} )}^{2} )$$

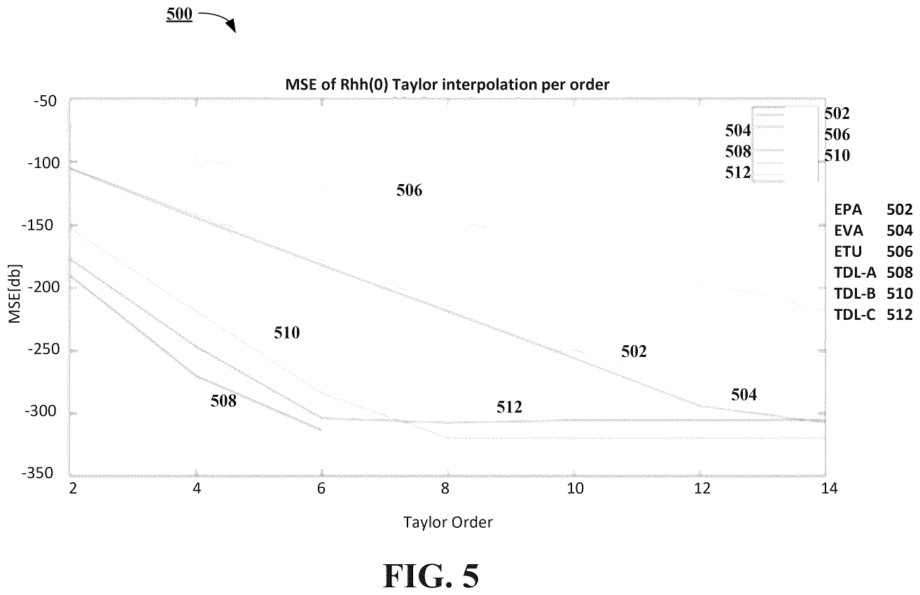

of the approximation versus the nominal values of a selected set of 3rd Generation Partnership Project (3GPP) channels with respect to the Taylor order assuming Δf=45 KHz as depicted in FIG. 5.

FIG. 5 is a diagram 500 of MSE of Rₕₕ[0] Taylor interpolation per order, illustrating Taylor Order versus MSE[dB] for EPA 502, EVA 504, ETU 506, TDL-A 508, TDL-B 510, and TDL-C 512.

As can be observed in FIG. 5, the MSE drops with the Taylor order as expected (and up to numeric limitations for the NR channels). The practical meaning of (6-9) is that if instead of the exact values of Rₕₕ[1:M] there is a noisy measurement of them, i.e., \hat{R}ₕₕ[1:M]=Rₕₕ[1:M]+n[1:M] where, n[1:M] is some zero mean noise, then using those samples we can achieve an unbiased noisy estimation of Rₕₕ[0] via

$${\hat{R}}_{h h} [ 0 ] = Re \{ {\hat{R}}_{h h} [ 1 ] \} - {c}_{r} {D}_{r}^{- 1} {\overline{p}}_{r}$$

where p̅ᵣ≙[Re{\hat{R}ₕₕ[1]−\hat{R}ₕₕ[2]}, . . . , Re{\hat{R}ₕₕ[M−1]−\hat{R}ₕₕ[M]}]. Further, defining for the imaginary part:

$${v}_{i} [ Δ f ] {=}^{Δ} {[ {v}_{i} [ 0 , Δ f ] , … , {v}_{i} [ M - 1 , Δ f ] ]}^{T} , {p}_{i} {=}^{Δ} {[ {p}_{i} [ 0 ] , … , {p}_{i} [ M - 1 ] ]}^{T} {=}^{Δ} {[ Im \{ {R}_{h h} [ 1 ] \} , … , Im \{ {R}_{h h} [ M ] \} ]}^{T} , {c}_{i} [ k ] {=}^{Δ} [ \frac{{k}^{1}}{1 !} , \frac{- {k}^{3}}{3 !} … , \frac{{( - 1 )}^{M - 1} {k}^{2 M - 1}}{( 2 M - 1 ) !} ] , {D}_{i} [ m , q ] {=}^{Δ} \frac{{( - 1 )}^{q} {( m + 1 )}^{2 q + 1}}{( 2 q + 1 ) !} , 0 \leq m , q \leq M - 1 \qquad ( 11 )$$

then the following can be stated:

$${p}_{i} ≅ {D}_{i} {v}_{i} [ Δ f ] ⇒ {v}_{i} [ Δ f ] ≅ {D}_{i}^{- 1} {p}_{i} \qquad ( 12 )$$

Which means that practically

$${v}_{i} [ 0 , Δ f ] = {\sum }_{n = 0}^{{N}_{p t} - 1} {{P}_{n} ( 2 π Δ f {τ}_{n} )}^{1}$$

can be estimated and used in (4) if p̅ᵢ≙[p̅ᵢ[0], . . . , p̅ᵢ[M−1]]^{T}≙[Im{\hat{R}ₕₕ[1]}, . . . , Im{\hat{R}ₕₕ[M]}]^{T} is used in (12) instead of pᵢ. These important properties will be used in the below. Estimation of Rₕₕ[k], 0≤k≤K_{R}_{_{yy}}.

First, it is known that the FD OFDM signal satisfies:

$${R}_{y y} [ k ] = \{ \begin{matrix}{R}_{h h} [ 0 ] + {R}_{n n} [ 0 ] & k = 0 \\ {R}_{h h} [ k ] & k > 0\end{matrix} \qquad ( 13 )$$

Meaning, if we can estimate R_{yy}[k], we can derive Rₕₕ[k] from it (at least for k>0). Thus, an alternative to the PDP based Rₕₕ estimation is estimating R_{yy} directly, for example, no Inverse Fast Fourier Transform (IFFT) and collectively for all antennas using the 63 taps of the FD M-sequence removed SSS signal, meaning:

$${\overline{R}}_{y y} [ k ] {=}^{Δ} \frac{1}{{N}_{r x} ( 63 - k - {N}_{DCMult} [ k ] )} {\sum }_{m = 0}^{62 - k} {y}^{H} [ m + k ] Λ y [ m ] = a [ k ] {\sum }_{m = 0}^{62 - k} {y}^{H} [ m + k ] Λ y [ m ] = {\sum }_{{i}_{r x} = 0}^{{N}_{r x} - 1} Λ [ {i}_{rx} , {i}_{r x} ] {\overline{R}}_{y y , {i}_{r x}} [ k ] \qquad ( 14 )$$

Where Λ is a diagonal weighting matrix and R̅_{yy,i}_{ᵣₓ}[k] is the per antenna sample of R_{yy,i}_{ᵣₓ}[k] which satisfies:

$${\overline{R}}_{y y , {i}_{r x}} [ k ] {=}^{Δ} a [ k ] {\sum }_{m = 0}^{62 - k} {y}_{{i}_{r x}}^{*} [ m + k ] \cdot {y}_{{i}_{r x}} [ m ] = a [ k ] {\sum }_{m = 0}^{62 - k} ( {h}_{{i}_{r x}}^{*} [ m + k ] + {n}_{{i}_{r x}}^{*} [ m + k ] ) ( {h}_{{i}_{r x}} [ m ] + {n}_{{i}_{r x}} [ m ] ) = a [ k ] {\sum }_{m = 0}^{62 - k} {h}_{{i}_{r x}}^{*} [ m + k ] {h}_{{i}_{r x}} [ m ] + a [ k ] {\sum }_{m = 0}^{62 - k} {h}_{{i}_{r x}}^{*} [ m + k ] {n}_{{i}_{r x}} [ m ] + {h}_{{i}_{r x}} [ m ] {n}_{{i}_{r x}}^{*} [ m + k ] + {n}_{{i}_{r x}}^{*} [ m + k ] {n}_{{i}_{r x}} [ m ] {=}^{Δ} {\tilde{R}}_{hh , {i}_{r x}} [ k ] + {n}_{{i}_{r x}} [ k ] \qquad ( 15 )$$

And \tilde{R}_{hh,i}_{ᵣₓ}[k], k>0 may be regarded as the wanted value while ñiᵣₓ[k] may be regarded as its zero average estimation error for antenna iᵣₓ.

$$y [ m ] {=}^{Δ} {[ {y}_{0} [ m ] , … , {y}_{{N}_{r x} - 1} [ m ] ]}^{T} = {[ {h}_{0} [ m ] + {n}_{0} [ m ] , … , {h}_{{N}_{r x} - 1} [ m ] + {n}_{{N}_{r x} - 1} [ m ] ]}^{T} {=}^{Δ} h [ m ] + n [ m ]$$

is the SSS noisy signal at the m^{th} subcarrier (SC).

$$n [ m ] ∼ N ( 0 , [ \begin{matrix}{σ}_{0}^{2} & … & 0 \\ ⋮ & ⋱ & ⋮ \\ 0 & … & {σ}_{{N}_{r x} - 1}^{2}\end{matrix} ] )$$

y[31] is the DC sub-carrier hence its measurement is discarded by setting y[31]=0, therefore

$${N}_{DCMult} [ k ] {=}^{Δ} \{ \begin{matrix}0 & k > 31 \\ 1 & k = 0 \\ 2 & o . w .\end{matrix}$$

As can be inferred from (14), R_{yy}[k] differs from R_{yy}[k] because of the following reasons (1) due to the additive noise n[m] and (2) R̅_{yy}[k] is a result of a calculation over a single instance of the SSS and thus may not completely reflect the overall statistic properties of the channel. Therefore, it is reasonable to filter R̅_{yy}[k] over time using e.g., a (leaky) exponential (alpha) filter:

$${\hat{R}}_{y y} [ k , t + 1 ] = ( 1 - {α}_{{R}_{y y}} ) {\hat{R}}_{y y} [ k , t ] + γ {α}_{{R}_{y y}} [ t + 1 ] {\overline{R}}_{y y} [ k ] \qquad ( 16 )$$

Where α_{R}_{_{yy}}[t+1] may be set dynamically or according to:

$${α}_{{R}_{y y}} [ t + 1 ] = max \{ {α}_{{R}_{yy} , min} , \frac{1}{t + 1} \} , t \geq 0 \qquad ( 17 )$$

That is according to (17), the alpha filter is somewhat a bandwidth (BW) decreasing filter which will eventually cause the convergence of \hat{R}_{yy}→R_{yy}, however, α_{R}_{_{yy}}[t+1] is not limited to the definition of (17) Estimation of the weighting factors Λ and γ Using the Taylor Expansion approximation of.

$${R}_{hh , {i}_{r x}} [ 0 ]$$

Observing (15), the variance of the estimation error is:

$${σ}_{{\tilde{n}}_{{i}_{r x}} [ k ]}^{\underline{2}} = E \{ {\tilde{n}}_{{i}_{r x}} [ k ] {\tilde{n}}_{{i}_{r x}}^{*} [ k ] \} \approx {\vert a [ k ] \vert}^{2} {\sum }_{m = 0}^{62 - k} E \{ {\vert {h}_{{i}_{r x}}^{*} [ m + k ] \vert}^{2} \} E \{ {\vert {n}_{{i}_{r x}} [ m ] \vert}^{2} \} + E \{ {\vert {h}_{{i}_{r x}} [ m ] \vert}^{2} \} E \{ {\vert {n}_{{i}_{r x}}^{*} [ m + k ] \vert}^{2} \} + E \{ {\vert {n}_{{i}_{r x}} [ m ] \vert}^{2} \} E \{ {\vert {n}_{{i}_{r x}}^{*} [ m + k ] \vert}^{2} \} = \vert a [ k ] \vert ( E \{ {\vert {h}_{{i}_{r x}}^{*} [ m + k ] \vert}^{2} \} E \{ {\vert {n}_{{i}_{r x}} [ m ] \vert}^{2} \} + E \{ {\vert {h}_{{i}_{r x}} [ m ] \vert}^{2} \} E \{ {\vert {n}_{{i}_{r x}}^{*} [ m + k ] \vert}^{2} \} + E \{ {\vert {n}_{{i}_{r x}} [ m ] \vert}^{2} \} E \{ {\vert {n}_{{i}_{r x}}^{*} [ m + k ] \vert}^{2} \} ) = \vert a [ k ] \vert {σ}_{{i}_{r x}}^{2} ( 2 {s}_{{i}_{r x}} + {σ}_{{i}_{r x}}^{2} ) {=}^{Δ} \vert a [ k ] \vert {σ}_{{\tilde{n}}_{{i}_{r x}}}^{\underline{2}} \qquad ( 18 )$$

Where sᵢ_{ᵣₓ}≙R̅_{nh,i}_{ᵣₓ}[0] and

$${σ}_{{i}_{r x}}^{2}$$

are the instantaneous average signal and noise powers of the current SSS signal at antenna iᵣₓ respectively. Further, it can also be noted that

$${σ}_{{\tilde{n}}_{{i}_{r x}} [ k ]}^{\underline{2}}$$

grows with k since |a[k] | grows with k. Defining:

$${\overline{p}}_{r} {=}^{Δ} {[ Re \{ {\overline{R}}_{yy , {i}_{r x}} [ 1 ] - {\overline{R}}_{yy , {i}_{r x}} [ 2 ] \} , … , Re \{ {\overline{R}}_{yy , {i}_{r x}} [ M - 1 ] - {\overline{R}}_{yy , {i}_{r x}} [ M ] \} ]}^{T} \qquad ( 19 )$$

We can use (9), i.e., the Taylor Expansion Approximation of R̅_{hh,i}_{ᵣₓ}[0] (of the current sample) in the following manner:

$${\overline{R}}_{hh , {i}_{r x}} [ 0 ] = Re \{ {\overline{R}}_{y y , {i}_{r x}} [ 1 ] \} - {c}_{r} {D}_{r}^{- 1} {\overline{p}}_{r} . \qquad ( 20 )$$

That is, in contrast to (9) where the deterministic (not noisy) values of the autocorrelation function were used in order to estimate Rₕₕ[0] (almost) exactly, here the noisy samples of R̅_{yy,i}_{ᵣₓ}[1:M] are used to analytically approximate R_{hh,i}_{ᵣₓ}[0] while suppressing the measurements noise as much as possible. Thus, using (18,20),

$${σ}_{{\tilde{n}}_{{i}_{r x}}}^{2}$$

can be estimated by:

$${\hat{σ}}_{{\tilde{n}}_{{i}_{r x}}}^{\underline{2}} = \vert ( {\overline{R}}_{y y , {i}_{r x}} [ 0 ] - {\overline{R}}_{hh , {i}_{r x}} [ 0 ] ) ( {\overline{R}}_{yy , {i}_{r x}} [ 0 ] + {\overline{R}}_{hh , {i}_{r x}} [ 0 ] ) \vert \qquad ( 21 )$$

Which in turn can be used to define Λ as −.

$$μ {=}^{Δ} {\sum }_{{i}_{rx} = 0}^{{N}_{r x} - 1} \frac{1}{\sqrt{{\hat{σ}}_{{\tilde{n}}_{{i}_{r x}}}^{2}}} , \qquad ( 22 )$$

$$Λ {=}^{Δ} \frac{1}{μ} [ \begin{matrix}\frac{1}{\sqrt{{\hat{σ}}_{{\tilde{n}}_{0}}^{2}}} & … & 0 \\ ⋮ & ⋱ & ⋮ \\ 0 & … & \frac{1}{\sqrt{{\hat{σ}}_{{\tilde{n}}_{{N}_{r x} - 1}}^{2}}}\end{matrix} ] . \qquad ( 23 )$$

The rational of (23) is to weight the samples of each antenna such that post weighting, the combined instantaneous power of the error would be

$$\overline{P} err {=}^{Δ} \frac{1}{{μ}^{2}} .$$

This can be used to define a filtering rule for the power of the error via:

$${\hat{P}}_{e r r} [ t + 1 ] = ( 1 - {α}_{{R}_{y y}} ) {\hat{P}}_{e r r} [ t ] + {α}_{{R}_{y y}} [ t + 1 ] {\overline{P}}_{e r r} \qquad ( 24 )$$

Which in turn is used to define the proper γ as:

$$γ {=}^{△} \sqrt{\frac{{\hat{P}}_{err}}{{\overline{P}}_{err}}} \qquad ( 25 )$$

That is, the γ is used to further weight the current R̅_{yy}[k] such that when it is taken at lower CINR conditions it will have less effect on the filtered \hat{R}_{yy} and vice versa. To conclude, both Λ and γ are determinantal for the quick convergence of \hat{R}_{yy}→R_{yy}. Estimation of Rₕₕ[0] Using the Taylor Expansion Approximation of Rₕₕ[0]. The value of Rₕₕ[0] needs to be determined with respect to the filtered \hat{R}_{yy}[k, t+1] values and can use the same calculation as the per antenna calculation, that is:

$${\hat{R}}_{hh} [ 0 ] {=}^{△} max \{ max \{ \vert {\hat{R}}_{yy} [ 1 : {K}_{{R}_{yy}} , t + 1 ] \vert \} , {c}_{r} [ 1 ] {D}_{r}^{- 1} {\overline{\overline{p}}}_{r} \} = max \{ max \{ \vert {\hat{R}}_{yy} [ 1 : {K}_{{R}_{yy}} , t + 1 ] \vert \} , {c}_{r} [ 1 ] {\overline{\overline{v}}}_{r} [ Δ f ] \} , \qquad ( 26 )$$

$${\overline{\overline{p}}}_{r} = {[ Re \{ {\hat{R}}_{yy} [ 1 , t + 1 ] - {\hat{R}}_{yy} [ 2 , t + 1 ] \} , … , Re \{ {\hat{R}}_{yy} [ M - 1 , t + 1 ] - {\hat{R}}_{yy} [ M , t + 1 ] \} ]}^{T} . \qquad ( 27 )$$

The reason for this biased solution is to never allow Rₕₕ[0] be smaller than the absolute value of any of the other values of \hat{R}_{yy} 1:K_{R}_{_{yy}}, t+1| as the definition of the function restricts. This of course will never provide the most accurate result, but over time it will converge to the correct value.

Estimation of the CINR Using the Taylor Expansion approximation of R_{hh,i}_{ᵣₓ}[0].

Using R̅_{yy,i}_{ᵣₓ}[0] of (15) and R̅_{hh,i}_{ᵣₓ}[0] of (20) the following filtering rules are defined:

$${\hat{R}}_{hh}^{CINR} [ 0 , t + 1 ] = ( 1 - {α}_{CINR} ) {\hat{R}}_{hh}^{CINR} [ 0 , t ] + {\sum }_{{i}_{rx} = 0}^{{N}_{rx} - 1} \frac{{α}_{CINR} [ t + 1 ]}{{g}_{{i}_{rx}}} {\overline{R}}_{hh , {i}_{rx}} [ 0 ] , \qquad ( 28 )$$

$${\hat{R}}_{yy}^{CINR} [ 0 , t + 1 ] = ( 1 - {α}_{CINR} ) {\hat{R}}_{yy}^{CINR} [ 0 , t ] + {\sum }_{{i}_{rx} = 0}^{{N}_{rx} - 1} \frac{{α}_{CINR} [ t + 1 ]}{{g}_{{i}_{rx}}} {\overline{R}}_{yy , {i}_{rx}} [ 0 ] , \qquad ( 29 )$$

$${α}_{CINR} [ t + 1 ] = max \{ {α}_{CINR , min} , \frac{1}{t + 1} \} , t \geq 0 \qquad ( 30 )$$

Where g≙ [g₀, . . . , g_{N}_{ᵣₓ}₋₁] are the total (power) gains from the Analog-to-Digital Converter (ADC) to the FD data branch per antenna and α_{CINR}[t+1] can be adjusted according to (30) or some other dynamic setting with the tradeoff of either fast tracking or accuracy depending on the requirements. Using (28-30) the filtered CINR can be estimated as:

$$[ t + 1 ] {=}^{△} \vert \frac{{\hat{R}}_{hh}^{CINR} [ 0 , t + 1 ]}{{\hat{R}}_{yy}^{CINR} [ 0 , t + 1 ] - {\hat{R}}_{hh}^{CINR} [ 0 , t + 1 ]} \vert . \qquad ( 31 )$$

Estimation Of The Average And RMS Delay Spread Using the Taylor Expansion approximation of

$${\sum }_{n = 0}^{{N}_{pt} - 1} {P}_{n} {τ}_{n} .$$

The average and RMS delay spread are typically defined in terms of the PDP.

$$\overline{τ} {=}^{△} \frac{{\sum }_{n = 0}^{{N}_{pt} - 1} {P}_{n} {τ}_{n}}{{\sum }_{n = 0}^{{N}_{pt} - 1} {P}_{n}} = \frac{{\sum }_{n = 0}^{{N}_{pt} - 1} {P}_{n} {τ}_{n}}{{R}_{hh} [ 0 ]} , \qquad ( 32 )$$

$${τ}_{RMS} {=}^{△} \sqrt{\frac{{\sum }_{n = 0}^{{N}_{pt} - 1} {{P}_{n} ( {τ}_{n} - \overline{τ} )}^{2}}{{\sum }_{n = 0}^{{N}_{pt} - 1} {P}_{n}}} = \sqrt{\frac{{\sum }_{n = 0}^{{N}_{pt} - 1} {{P}_{n} ( {τ}_{n} - \overline{τ} )}^{2}}{{R}_{hh} [ 0 ]}} . \qquad ( 33 )$$

Using (12) and (26), τ̅ can be estimated according to:

$$\hat{\overline{τ}} {=}^{△} \frac{{v}_{l} [ ]}{2 πΔ f {\hat{R}}_{hh} [ 0 , t + 1 ]} = \frac{{D}_{i}^{- 1} [ 0 , 0 : M - 1 ] {\overline{p}}_{i}}{2 πΔ f {\hat{R}}_{hh} [ 0 , t + 1 ]} , \qquad ( 34 )$$

And then the RMS delay spread may be calculated as well:

$${\hat{τ}}_{RMS} {=}^{△} \sqrt{\frac{{\sum }_{n = 0}^{{N}_{pt} - 1} {{P}_{n} ( {τ}_{n} - \hat{\overline{τ}} )}^{2}}{{\hat{R}}_{hh} [ 0 , t + 1 ]}} = \sqrt{\frac{{\sum }_{n = 0}^{{N}_{pt} - 1} {P}_{n} {τ}_{n}^{2} - 2 \hat{\overline{τ}} {P}_{n} {τ}_{n} + {\hat{\overline{τ}}}^{2} {P}_{n}}{{\hat{R}}_{hh} [ 0 , t + 1 ]}} ≅ \sqrt{\frac{\vert \frac{{\overline{\overline{v}}}_{r} [ 0 , Δ f ]}{{( 2 πΔ f )}^{2}} - {\hat{\overline{τ}}}^{2} {\hat{R}}_{hh} [ 0 , t + 1 ] \vert}{{\hat{R}}_{hh} [ 0 , t + 1 ]}} \qquad ( 35 )$$

### Extrapolation of Rₕₕ for

$$Δ {f}^{′} = \frac{Δ f}{l}$$

Suppose that \hat{R}ₕₕ[0: M, t+1] is acquired as described above with a sub carrier spacing of Δf=l·Δf′ with l being a positive integer, and we wish to derive the values of Rₕₕ with a sub carrier spacing of

$$Δ {f}^{′} = \frac{Δ f}{l} .$$

For instance, the Long Term Evolution (LTE, 3GPP 4G technology) CRS signal has a separation of Δf=6·15e3 Hz and Rₕₕ is measured with this separation, then we could derive the values with a separation of

$$Δ {f}^{′} = \frac{6 \cdot 15 e 3 Hz}{6} = 15 e 3 Hz .$$

Using the v̅ᵣ[Δf] and v̅ᵢ[Δf] measured vectors define.

$${\overline{\overline{v}}}_{r} [ \frac{Δ f}{l} ] {=}^{△} [ \begin{matrix}\frac{1}{{l}^{2}} & 0 & … & 0 \\ 0 & \frac{1}{{l}^{4}} & 0 & ⋮ \\ ⋮ & 0 & ⋱ & 0 \\ 0 & … & 0 & \frac{1}{{l}^{2 ( M - 1 )}}\end{matrix} ] {\overline{\overline{v}}}_{r} [ Δ f ] , \qquad ( 36 )$$

$${\overline{\overline{v}}}_{r} [ \frac{Δ f}{l} ] {=}^{△} [ \begin{matrix}\frac{1}{{l}^{1}} & 0 & … & 0 \\ 0 & \frac{1}{{l}^{3}} & 0 & ⋮ \\ ⋮ & 0 & ⋱ & 0 \\ 0 & … & 0 & \frac{1}{{l}^{2 ( M - 1 ) + 1}}\end{matrix} ] {\overline{\overline{v}}}_{r} [ Δ f ] , \qquad ( 37 )$$

then the extrapolated [symbol] ₕₕ[k, t+1] for 0≤k≤Ml with sub carrier spacing Δf/l can be calculated using (7,11) via:

$${hh}_{} [ k , t + 1 ] = \{ \begin{matrix}{\hat{R}}_{hh} [ 0 , t + 1 ] , & k = 0 \\ {\hat{R}}_{hh} [ 0 , t + 1 ] + {c}_{r} [ k ] {\overline{\overline{v}}}_{r} [ \frac{Δ f}{l} ] + j \cdot {c}_{i} [ k ] {\overline{\overline{v}}}_{i} [ \frac{Δ f}{l} ] , & k > 0\end{matrix} \qquad ( 38 )$$

Autocorrelation function estimation may be used in a communication system and/or a communication device for channel characterization, noise reduction, and/or efficient communication system operation. Autocorrelation function estimation applications span from foundational synchronization tasks to advanced techniques like adaptive Multiple Input Multiple Output (MIMO) and resource allocation.

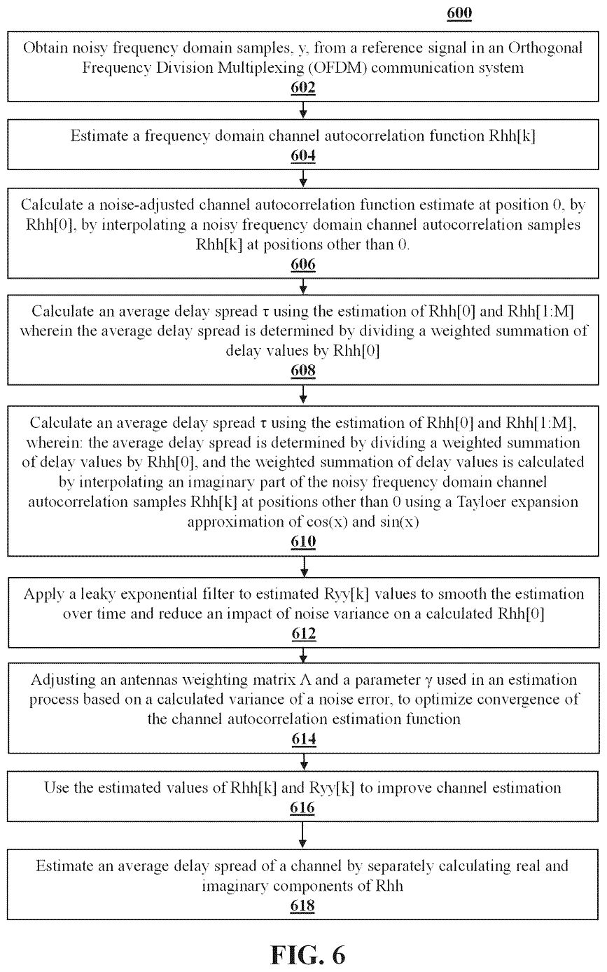

FIG. 6 is a flowchart illustrating an example method 600 in accordance with the systems and methods described herein. In some implementations, one or more process blocks of FIG. 6 may be performed by a device. As illustrated in FIG. 6, method 600 may include obtaining noisy frequency domain samples, y[m], from a reference signal in an Orthogonal Frequency Division Multiplexing (OFDM) communication system (block 602). For example, a device may obtain noisy frequency domain samples, y[m], from a reference signal in an orthogonal frequency division multiplexing (OFDM) communication system, as described above. As also illustrated in FIG. 7, process 600 may include estimating a frequency domain channel autocorrelation function Rₕₕ[k] (block 604). For example, a device may estimate a frequency domain channel autocorrelation function, as described above. As further illustrated in FIG. 7, process 700 may include calculating a noise-reduced channel autocorrelation function estimate at position 0, Rₕₕ[0], by interpolating a noisy frequency domain channel autocorrelation samples Rₕₕ[k] at positions other than 0 (block 706). For example, the device may calculate a noise-reduced channel autocorrelation function estimate at position 0, rhh[0], by interpolating a noisy frequency domain channel autocorrelation samples rhh[k] at positions other than 0, as described above.

Process 600 may include additional implementations, such as any single implementation or any combination of implementations described below and/or in connection with one or more other processes described elsewhere herein. A first implementation, process 700 may include calculating an average delay spread τ using the estimation of Rₕₕ[0] and Rₕₕ[1:M], wherein the average delay spread is determined by dividing a weighted summation of delay values by Rₕₕ[0].

A second implementation, alone or in combination with the first implementation, process 600 may include calculating an average delay spread t using the estimation of Rₕₕ[0] and Rₕₕ[1:M], wherein: the average delay spread is determined by dividing a weighted summation of delay values by Rₕₕ[0], and the weighted summation of delay values is calculated by interpolating an imaginary part of the noisy frequency domain channel autocorrelation samples Rₕₕ[k] at positions other than 0 using a Taylor expansion approximation of cos(x) and sin(x).

A third implementation, alone or in combination with the first and second implementation, process 600 may include applying a leaky alpha filter to estimated R_{yy}[k] values to smooth the estimation over time and reduce an impact of noise variance on a calculated Rₕₕ[0].

A fourth implementation, alone or in combination with one or more of the first through third implementations, process 600 may include adjusting an antennas weighting matrix A and a parameter γ used in an estimation process based on a calculated variance of a noise error, to optimize convergence of the channel autocorrelation estimation function.

A fifth implementation, alone or in combination with one or more of the first through fourth implementations, process 600 may include using the estimated values of Rₕₕ[k] and R_{yy}[k] to improve channel estimation accuracy.

A sixth implementation, alone or in combination with one or more of the first through fifth implementations, process 600 may include estimating an average delay spread of a channel by separately calculating real and imaginary components of Rₕₕ[k] and utilizing these components to enhance system timing configurations.

Although FIG. 6 illustrates example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The preceding disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like) and may be used interchangeably with “one or more.” The phrase “only one” or similar language is used where only one item is intended. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

One or more elements or aspects or steps, or any portion(s) thereof, from one or more of any of the systems and methods described herein, may be combined with one or more elements or aspects or steps, or any portion(s) thereof, from one or more of any of the other systems and methods described herein and combinations thereof, to form one or more additional implementations and/or claims of the present disclosure.

One or more components, steps, features, and/or functions illustrated in the figures may be rearranged and/or combined into a single component, feature, or function. Additional elements, components, steps, and/or functions may also be added without departing from the disclosure. The apparatus, devices, and/or components illustrated in the Figures may be configured to perform one or more of the methods, features, or steps described in the Figures.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily refer to the same embodiment.

The figures and the description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this Application. As will be understood by those familiar with the art, the present invention may be embodied in other specific forms without departing from the spirit or essential characteristics thereof. Likewise, the naming and division of the mechanisms, components, and features are not mandatory or significant, and the mechanisms that implement the present invention or its features may have different names, divisions and/or formats.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method for frequency domain channel autocorrelation function estimation in a communication system, comprising:
obtaining noisy frequency domain samples, y[m], from a reference signal in an Orthogonal Frequency Division Multiplexing (OFDM) communication system;
estimating a frequency domain channel autocorrelation function Rₕₕ[k]; and
calculating a noise-reduced channel autocorrelation function estimate at position 0, Rₕₕ[0], by interpolating a noisy frequency domain channel autocorrelation samples Rₕₕ[k] at positions other than 0.

2. The method of claim 1, wherein the reference signal comprises at least one of:
a cell-specific reference signal (C-RS),
a demodulation reference signal (DM-RS),
a channel state information reference signal (CSI-RS),
a secondary synchronization signal (SSS) of the synchronization signal block (SSB), or
an other reference signals defined in the communication system.

3. The method of claim 1, wherein the interpolation of the noisy frequency domain channel autocorrelation samples Rₕₕ[k] at position 0 is performed using a Taylor expansion approximation of cos(x) and sin(x) functions and the noisy frequency domain channel autocorrelation samples Rₕₕ[k] at positions other than 0 to improve accuracy.

4. The method of claim 1, further comprising calculating an average delay spread t using the estimation of Rₕₕ[0] and Rₕₕ[1:M], wherein the average delay spread is determined by dividing a weighted summation of delay values by Rₕₕ[0].

5. The method of claim 1, further comprising calculating an average delay spread T using the estimation of Rₕₕ[0] and Rₕₕ[1:M], wherein:
the average delay spread is determined by dividing a weighted summation of delay values by Rₕₕ[0], and
the weighted summation of delay values is calculated by interpolating an imaginary part of the noisy frequency domain channel autocorrelation samples Rₕₕ[k] at positions other than 0 using a Taylor expansion approximation of cos(x) and sin(x).

6. The method of claim 1, wherein carrier-to-interference-plus-noise ratio (CINR) is calculated according to:
$$CINR = \frac{{R}_{hh} [ 0 ]}{{R}_{yy} [ 0 ] - {R}_{hh} [ 0 ]}$$
where R_{yy}[0] represents an estimation of the autocorrelation of noisy samples y[m] at zero lag.

7. The method of claim 1, further comprising applying a leaky alpha filter to estimated R_{yy}[k] values to smooth the estimation over time and reduce an impact of noise variance on a calculated Rₕₕ[0].

8. The method of claim 1, wherein values of Rₕₕ[k] for a smaller sub-carrier spacing Δf=Δf/l are extrapolated from the calculated values of Rₕₕ[0:M, t+1] using a Taylor expansion approximation matrix transformation.

9. The method of claim 1, further comprising using the estimated values of Rₕₕ[k] and R_{yy}[k] to improve channel estimation accuracy.

10. The method of claim 1, wherein the channel autocorrelation function Rₕₕ[k] is estimated using both real and imaginary components of the noisy frequency domain samples to calculate channel delay spread and interference noise characteristics.

11. The method of claim 1, wherein the estimation of Rₕₕ[k] includes adjusting a calculation resolution by applying interpolation techniques to reference signals with a lower subcarrier density.

12. The method of claim 1, wherein additional signal processing steps are applied to improve accuracy of the channel autocorrelation function estimation, comprising:
filtering noisy components from the reference signal, and
refining the frequency domain estimation using advanced interpolation algorithms.

13. The method of claim 1, wherein the channel autocorrelation function estimation is performed using weighted averaging of multiple reference signals to improve accuracy under varying noise and interference conditions.

14. A device configured for frequency domain channel autocorrelation function estimation in a communication system, the device comprising:
at least one memory; and
at least one processor coupled to the at least one memory, the at least one processor configured to:
obtain noisy frequency domain samples, y[m], from a reference signal in an Orthogonal Frequency Division Multiplexing (OFDM) communication system,
estimate a frequency domain channel autocorrelation function Rₕₕ[k], and
calculate a noise-reduced channel autocorrelation function estimate at position 0, Rₕₕ[0], by interpolating a noisy frequency domain channel autocorrelation samples Rₕₕ[k] at positions other than 0.

15. The device of claim 14, wherein the reference signal comprises at least one of:
a cell-specific reference signal (C-RS),
a demodulation reference signal (DM-RS),
a channel state information reference signal (CSI-RS),
a secondary synchronization signal (SSS) of the synchronization signal block (SSB), or
an other reference signals defined in the communication system.

16. The device of claim 14, wherein the interpolation of the noisy frequency domain channel autocorrelation samples Rₕₕ[k] at positions other than 0 is performed using a Taylor expansion approximation of cos(x) and sin(x) functions is used to interpolate the noisy frequency domain channel autocorrelation samples Rₕₕ[k] at positions other than 0 to improve accuracy.

17. The device of claim 14, further comprising calculating an average delay spread t using the estimation of Rₕₕ[0] and Rₕₕ[1:M], wherein the average delay spread is determined by dividing a weighted summation of delay values by Rₕₕ[0].
The weighted summation of delay values is determined by interpolating the imaginary part of the noisy frequency domain channel autocorrelation samples Rₕₕ[k] at positions other than 0.

18. The device of claim 14, further comprising calculating an average delay spread using the estimation of Rₕₕ[0] and Rₕₕ[1:M], wherein:
the average delay spread is determined by dividing a weighted summation of delay values by Rₕₕ[0], and
the weighted summation of delay values is calculated by interpolating an imaginary part of the noisy frequency domain channel autocorrelation samples Rₕₕ[k] at positions other than 0 using a Taylor expansion approximation of cos(x) and sin(x), thereby improving accuracy.

19. The device of claim 14, wherein carrier-to-interference-plus-noise ratio (CINR) is calculated according to:
$$CINR = \frac{{R}_{hh} [ 0 ]}{{R}_{yy} [ 0 ] - {R}_{hh} [ 0 ]}$$
where R_{yy}[0] represents an estimation of the autocorrelation of noisy samples y[m] at zero lag.

20. The device of claim 14, further comprising applying a leaky alpha filter to estimated R_{yy}[k] values to smooth the estimation over time and reduce an impact of noise variance on the calculated Rₕₕ[0].
